(19) United States
(12) Patent Application Publication
(10) Pub. No.: US 2023/0260275 A1
(43) Pub. Date: Aug. 17, 2023

(54) SYSTEM AND METHOD FOR IDENTIFYING OBJECTS AND/OR OWNERS

(71) Applicant: Whammy, Inc., Millbrook, NY (US)

(72) Inventors: Christian Ryan Ziegler, Millbrook, NY (US); Andrew Heaney, Millbrook, NY (US); Grant Kenji Larsen, Millbrook, NY (US)

(21) Appl. No.: 18/167,862

(22) Filed: Feb. 12, 2023

Related U.S. Application Data
(60) Provisional application No. 63/309,406, filed on Feb. 11, 2022.

(51) Int. Cl. G06V 20/13; G06V 20/50; G06V 20/60; G06V 10/764

(52) U.S. Cl. CPC G06V 20/13; G06V 20/50; G06V 20/60; G06V 10/764

(57) ABSTRACT

A method of identifying an item or items of interest may include receiving image data. The received image data may be associated with positional metadata. The method may identify one or more characteristics of the image data, the one or more characteristics being associated with presence of one or more items of interest at a particular site, and may determine, based on the one or more identified characteristics, that the particular site includes the item or items of interest. The method may further determine a geographic position of the particular site based on the positional metadata associated with the image data. A parcel of land that contains the determined geographic position may be determined, and communication with an owner of the parcel of land may be facilitated.

### RELATED APPLICATION

Under provisions of 35 U.S.C. § 119(e), the Applicant claims benefit of U.S. Provisional Application No. 63/309,406 filed on Feb. 11, 2022, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to systems and methods of feature identification. In particular, the disclosure relates to identifying particular objects or items of interest, and/or owners thereof.

### BACKGROUND

In some communities, such as rural and/or exurban communities, dwellings and other structures may be beyond the reach of municipal service providers, including natural gas service providers, cable service providers (e.g., television service providers, internet service providers, etc.), and/or the like. In such instances, owners may still require and/or desire services. For example gas may be required and/or desired for various purposes, including heating, vehicle operation, and/or cooking. In such cases, owners may rely on propane to meet gas needs. Propane serves an important need for energy usage at locations too distant to be connected to a gas main. As other examples, services provided may include swimming pool maintenance services, roof repair and/or maintenance services, and/or various other services. While not every example service is discussed below, the methods described are not intended to be limited to any particular type of services being provided.

Propane is typically delivered by truck and stored in a relatively large tank. Depending on environmental conditions and/or customer desires, the tank may be buried in the ground or may be an above-ground tank.

Propane gas deliveries may be scheduled individually, without use of long-term contracts. Accordingly, a property owner can select a different delivery company for each delivery. Moreover, customers for propane delivery companies tend to be geographically dispersed, by the nature of the properties on which tanks are needed. Accordingly, it can be difficult to find customers.

As another non-limiting example, television service and/or internet service may be desired for entertainment and information purposes. Moreover, cable providers typically also operate as internet service providers. Satellite providers may be relied on to provide television and/or Internet services to rural and exurban areas where cable providers do not operate.

Satellite service may be purchased via subscription or month-to-month, without use of long-term contracts. Moreover, customers for satellite service providers tend to be geographically dispersed, by the nature of the properties on which satellite service is needed. Accordingly, it can be difficult to find customers.

For at least these reasons, there is a need for better determination of potential customers for rural and exurban services, including propane gas delivery and satellite service provision.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of the present application may include methods, systems, and/or program products for identifying an item of interest, The platform may receive image data. The received image data may include or be accompanied by positional metadata. The method may identify an item of interest depicted within the image data. The method may further determine a geographic position of the item of interest based on the identified item of interest and the positional metadata included with the image data. A parcel of land that contains the determined geographic position may be determined, and communication with an owner of the parcel of land may be facilitated.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart illustrating a method for identifying owners of items of interest; and

FIG. 3 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of propane tank identification, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Details with regards to each module are provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specification. Each component disclosed for one module may be mixed with the functionality of another module. In the present disclosure, each component can be claimed on its own and/or interchangeably with other components of other modules.

An object identification platform may receive data, such as image data or other document data from various sources. The image data, such as aerial and/or satellite photography data, may be analyzed to locate and identify objects associated with services that may be provided to the object owners. For example, the image data may be analyzed for propane tanks, satellite dishes, swimming pools, building roofs, and/or other objects associated with services that may be depicted within the image data. The image data may include images of rural and exurban areas in which it is relatively common for properties to rely on services other than municipally-provided services. For example, these areas may rely on propane delivery rather than municipal natural gas mains, and/or may rely on satellite service for television and/or internet service rather than municipal (broadcast) television or cable television or internet services.

In embodiments, the platform module may identify certain features from visual characteristics of the image data. For example, the platform module may apply a machine learning model to the image data to identify the locations of one or more items of interest (e.g., propane tanks, satellite dishes, etc.) within the image data. In some embodiments, the platform module may include multiple machine learning models for use in identifying different items of interest (e.g., a first machine learning model for identifying propane tanks, a second machine learning model for identifying satellite dishes, etc.). In other embodiments, a single machine learning model may be capable of identifying multiple items of interest (e.g., a single machine learning model may identify both propane tanks and satellite dishes).

After identifying the location of one or more items of interest, the platform may determine a particular geographic position of the items of interest based on location metadata associated with the image data and a relative location of the item of interest within the image data. The platform may further determine a parcel of land that includes the determined geographic location using, for example, state, county, and/or city property records. In embodiments, the platform may facilitate communications between a platform operator and an owner, operator and/or resident of the identified parcel of land. Moreover, even where a particular item of interest (e.g., a propane tank) may not be visible, the platform may correlate various identified items to determine that a particular site is of interest to a service provider. As a non-limiting example, an underground tank may not be visible from the image data, but the identification of a pool and a particular type of flue or chimney, alone or in combination with information about fuel services in that area, may be correlated to impute the existence of a propane tank. Additionally or alternatively, lawn mowing patterns may be used to determine or impute a (suspected) location of an underground tank filling point, even if the filling point is not visible in the image data (e.g., given the resolution of satellite data), In particular, a machine learning model may be used to determine a likelihood of existence of an item of interest at a particular location given one or more attributes observed in the image data.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

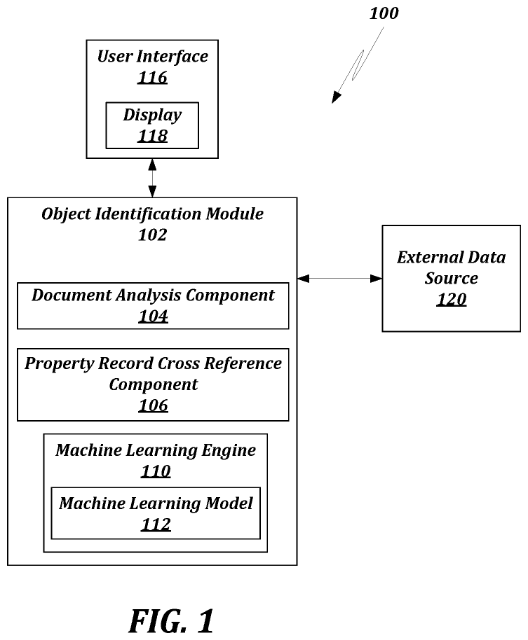

FIG. 1 illustrates one possible operating environment through which a platform consistent with embodiments of the present disclosure may be provided. By way of non-limiting example, an object identification platform 100 may be hosted on, for example, a cloud computing service. In some embodiments, the platform 100 may be hosted on a computing device 300. A user may access platform 100 through a software application and/or hardware device. The software application may be embodied as, for example, but not be limited to, a website, a web application, a desktop application, and a mobile application compatible with the computing device 300.

Accordingly, embodiments of the present disclosure provide a software and hardware platform comprised of a distributed set of computing elements, FIG. 1 illustrates an object identification platform 100 in accordance with one or more embodiments. As illustrated in FIG. 1, the platform 100 includes an object identification module 102, a user interface 116, an external data source 120, and various components thereof. In one or more embodiments, the platform 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, the user interface 116 refers to hardware and/or software configured to facilitate communications between a user and the object identification module 102. The user interface 116 may be used by a user who accesses an interface (e.g., a dashboard interface) for work and/or personal activities. The user interface 116 may be associated with one or more devices for presenting visual media, such as a display 118, including a monitor, a television, a projector, and/or the like. The user interface 116 may render user interface elements and/or receive input via user interface elements. Examples of interfaces include a graphical user interface (GUI), a command line interface (CLI), a haptic interface, and a voice command interface. Examples of user interface elements include checkboxes, radio buttons, menus, dropdown lists, list boxes, buttons, toggles, text fields, date and time selectors, command lines, sliders, pages, and forms.

In some embodiments, different components of the user interface 116 are specified in different languages. The behavior of user interface elements may be specified in a dynamic programming language, such as JavaScript. The content of user interface elements may be specified in a markup language, such as hypertext markup language (HTML) or XML User Interface Language (XUL). The layout of user interface elements is specified in a style sheet language, such as Cascading Style Sheets (CSS). Alternatively, the user interface 116 is specified in one or more other languages, such as Java, C, or C++.

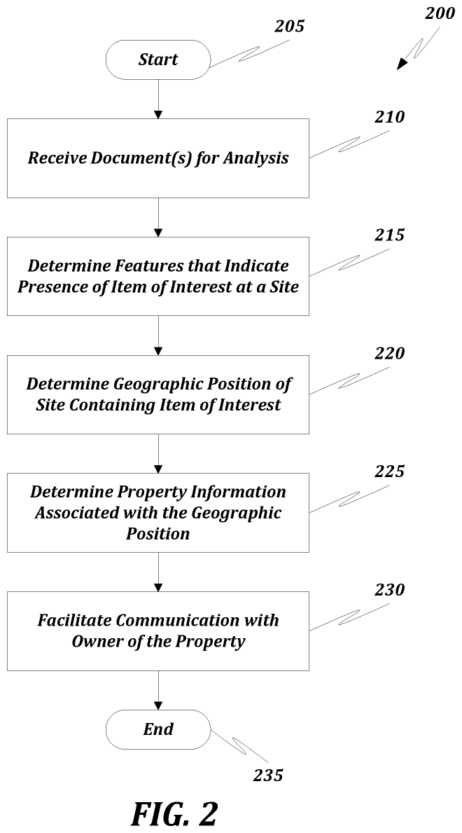

In one or more embodiments, the object identification module 102 refers to hardware and/or software configured to perform operations described herein for identifying objects or items of interest for a user. For example, the object identification module 102 may identify objects such as propane tanks, satellite dishes, and/or other objects associated with ongoing services provided to an owner of the objects. There are many examples of items of interest that may be identified using the object identification module 102. Examples of operations for identifying the objects or items of interest are described below with reference to FIG. 2.

In an embodiment, the object identification module 102 may include a document analysis component 104. The document analysis component 104 may refer to hardware and/or software configured to perform operations described herein (including such operations as may be incorporated by reference) for analyzing a document, such as a photograph, for evidence of an object of interest (e.g., a propane tank, a satellite dish, etc.) depicted in the document.

In an embodiment, the object identification module 102 includes a position determination component 106. The position determination component 104 may refer to hardware and/or software configured to perform operations described herein (including such operations as may be incorporated by reference) for determining a geographic position of an item of interest identified by the document analysis component 104.

In an embodiment, the propane tank identification module 102 includes a property record cross reference component 108. The property record cross reference component 108 may refer to hardware and/or software configured to determine a property address associated with the geographic position determined by the position determination component 106. In embodiments, the property record cross reference component 108 may further refer to hardware and/or software configured to determine one or more property owners associated with the determined address and/or one or more residents associated with the address.

In an embodiment, one or more components of the object identification module 102 use a machine learning engine 110. In particular, the machine learning engine 110 may be used to identify an item of interest (e.g., a propane tank, a satellite dish, etc.) depicted in a document. Machine learning includes various techniques in the field of artificial intelligence that deal with computer-implemented, user-independent processes for solving problems that have variable inputs. In particular, the machine learning model may receive, as inputs, various features associated with the presence of an item of interest (e.g., features of the item of interest itself, features that may be associated with the presence of an item of interest, correlations between characteristics of a site and the presence of an item of interest at the site, and/or the like). The output produced by the machine learning model may be an indication of the presence of an item of interest at a particular site, a likelihood of the presence of an item of interest at a particular site, or other indication concerning whether or not an item of interest was likely to be present based on the received data.

In some embodiments, the machine learning engine 110 may train a machine learning model 112 to perform one or more operations. Training a machine learning model 112 uses training data to generate a function that, given one or more inputs to the machine learning model 112, computes a corresponding output. The output may correspond to a prediction based on prior machine learning. In an embodiment, the output includes a label, classification, and/or categorization assigned to the provided input(s). The machine learning model 112 corresponds to a learned model for performing the desired operation(s) (e.g., labeling, classifying, and/or categorizing inputs). The object identification module 102 may use multiple machine learning engines 110 and/or multiple machine learning models 112 for different purposes. For example, the object identification module 102 may use a first machine learning engine 110 and/or a first machine learning model 112 to identify a first class of items of interest (e.g., propane tanks) and a second machine learning engine 110 and/or a second machine learning model 112 to identify a second class of items of interest (e.g., satellite dishes).

In an embodiment, the machine learning engine 110 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 110 receives positive and/or negative reinforcement in the process of attempting to solve a particular problem (e.g., to optimize performance in a particular scenario, according to one or more predefined performance criteria). In an embodiment, the machine learning engine 110 initially uses supervised learning to train the machine learning model 112 and then uses unsupervised learning to update the machine learning model 112 on an ongoing basis.

In an embodiment, a machine learning engine 110 may use many different techniques to label, classify, and/or categorize inputs. A machine learning engine 110 may transform inputs into feature vectors that describe one or more properties (“features”) of the inputs. The machine learning engine 110 may label, classify, and/or categorize the inputs based on the feature vectors. Alternatively or additionally, a machine learning engine 110 may use clustering (also referred to as cluster analysis) to identify commonalities in the inputs. The machine learning engine 110 may group (i.e., cluster) the inputs based on those commonalities. The machine learning engine 110 may use hierarchical clustering, k-means clustering, and/or another clustering method or combination thereof. For example, the machine learning engine 110 may receive, as inputs, one or more documents, such as one or more aerial photographs and/or one or more satellite photographs, and may identify one or more items of interest (e.g., an object such as a propane tank, a satellite dish, etc.) depicted in the one or more documents.

In an embodiment, a machine learning engine 110 includes an artificial neural network. An artificial neural network includes multiple nodes (also referred to as artificial neurons) and edges between nodes. Edges may be associated with corresponding weights that represent the strengths of connections between nodes, which the machine learning engine 110 adjusts as machine learning proceeds. Alternatively or additionally, a machine learning engine 110 may include a support vector machine. A support vector machine represents inputs as vectors. The machine learning engine 110 may label, classify, and/or categorize inputs based on the vectors. Alternatively or additionally, the machine learning engine 110 may use a naïve Bayes classifier to label, classify, and/or categorize inputs. Alternatively or additionally, given a particular input, a machine learning model may apply a decision tree to predict an output for the given input. Alternatively or additionally, a machine learning engine 110 may apply fuzzy logic in situations where labeling, classifying, and/or categorizing an input among a fixed set of mutually exclusive options is impossible or impractical. The aforementioned machine learning model 112 and techniques are discussed for exemplary purposes only and should not be construed as limiting one or more embodiments.

In an embodiment, as a machine learning engine 110 applies different inputs to a machine learning model 112, the corresponding outputs are not always accurate. As an example, the machine learning engine 110 may use supervised learning to train a machine learning model 112. After training the machine learning model 112, if a subsequent input is identical to an input that was included in labeled training data and the output is identical to the supervisory signal in the training data, then output is certain to be accurate. If an input is different from inputs that were included in labeled training data, then the machine learning engine 110 may generate a corresponding output that is inaccurate or of uncertain accuracy. In addition to producing a particular output for a given input, the machine learning engine 110 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In an embodiment, the object identification module 102 is configured to receive data from one or more external data sources 120. An external data source 120 refers to hardware and/or software operating independent of the search result association engine 102. For example, the hardware and/or software of the external data source 120 may be under control of a different entity (e.g., a different company or other kind of organization) than an entity that controls the object identification module 102. An example of an external data source 120 supplying data to the object identification module 102 may include a third party document provider, such as a third party that provides aerial photography or satellite photography images. Another example of an external data source 120 supplying data to the platform 100 may include a property record database maintained by, for example, a state, county, or city government. Many different kinds of external data sources 120 may supply many different kinds of data.

In an embodiment, the object identification module 102 is configured to retrieve data from an external data source 120 by ‘pulling’ the data via an application programming interface (API) of the external data source 120, using user credentials that a user has provided for that particular external data source 120. Alternatively or additionally, an external data source 120 may be configured to ‘push’ data to the object identification module 102 via an API of the query suggestion service, using an access key, password, and/or other kind of credential that a user has supplied to the external data source 120. The platform 100 may be configured to receive data from an external data source 120 in many different ways.

In an embodiment, the platform 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### III. Platform Operation

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

A. Object Owner Identification

Consistent with embodiments of the present disclosure, a method may be performed by at least one of the aforementioned modules. The method may be embodied as, for example, but not limited to, computer instructions, which when executed, perform the method.

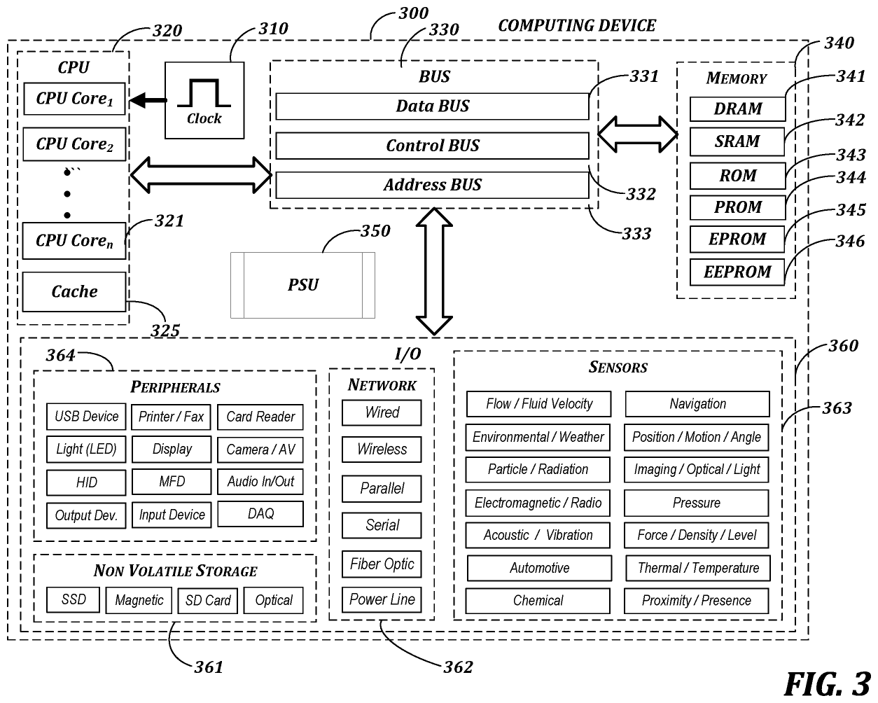

FIG. 2 is a flow chart setting forth the general stages involved in a method 200 for identifying objects and/or items of interest (e.g., a propane tank, a satellite dish, or any other item of interest) and owners thereof, consistent with an embodiment of the disclosure. Method 200 may be implemented using a computing device 300 or any other component associated with platform 100 as described in more detail below with respect to FIG. 3. For illustrative purposes alone, computing device 300 is described as one potential actor in the following stages.

Method 200 may begin at starting block 205 and proceed to stage 210 where computing device 300 may receive one or more documents for analysis. In embodiments, one or more documents may include one or more images. For example, the documents may include one or more aerial photography images, one or more drone photography images, one or more satellite photography images, one or more street-level photography images, and/or any other images.

In some embodiments, each image may include metadata and/or be accompanied by an associated metadata file, such as positional metadata identifying a geographic position associated with the image data that makes up the image. For example, the metadata may include global positioning system (GPS) coordinates associated with the image data, latitude and longitude coordinates associated with the image data, or any other position data associated with the image data.

After receiving the one or more images in stage 210, the method 200 may proceed to stage 215, where the computing device may identify a plurality of features or characteristics in the image data which may indicate the presence of one or more items of interest, such as one or more propane tanks, one or more propane pressure regulators, one or more satellite dishes, and/or any other item of interest, within the received image data. In some embodiments, the computing device may identify one or more characteristics of the item of interest in the image data. For example, if the item of interest is a propane tank, the computing device may identify an outline of a propane tank. Similarly, if the item of interest is a swimming pool, the computing device may identify the shape of a swimming pool in the image data.

Additionally or alternatively, the computing device may identify one or more features at a site that, alone or when considered together, are indicative of the presence of an item of interest. As a non-limiting example, an underground tank may not be visible from the image data, hut the computing device may identify a pool and a particular type of flue or chimney at a site. These identified features, alone or in combination with information about fuel services at the site, may be correlated to impute the existence of a propane tank at the site, even if no tank is identified in the image data. Similarly, lawn mowing patterns may be used to determine or impute a (suspected) location of an underground tank filling point, even if the filling point is not visible in the image data (e.g., given the resolution of satellite data).

In some embodiments, determining the presence of an item of interest at a site may include determining a confidence level associated with the presence of the item of interest. For example, the system may determine that it is 70% likely that an object or item of interest is present at a particular site within the image data, based on the determined characteristics of the item of interest and/or the determined characteristics indicative of the presence of an item of interest.

At stage 220, the computing device may determine a geographic position associated with a site that includes the item or items of interest determined in stage 215. For example, the image data may be associated with metadata that indicates a geographic area included in the image data. Based on a relative position of the site within the image data, the system may determine a geographic position of the site.

In some embodiments, the system may determine a geographic position for each of the determined features located within the image data. In some embodiments, the system may determine a geographic position for each feature associated with a confidence level that exceeds a threshold value.

At stage 225, the system may determine property information associated with the determined geographic position. For example, the system may cross reference municipal property records that include geographic position information associated with parcels of land to determine a land parcel associated with the geographic position of the item of interest. In some embodiments, the system may further rely on deed records associated with the parcel of land to determine a current owner of the parcel of land.

In some embodiments, the system may optionally determine if the image data includes evidence of one or more safety issues associated with the item of interest. As a particular example, the system may determine whether the image data includes evidence of a current propane leak adjacent to a propane tank.

In some embodiments, the system may facilitate communication with an owner or operator of the parcel of land at stage 230. For example, the system may allow for a system user to send communications to one or more residents of the parcel using a mail delivery service, a courier service, or the like. As another example, the system may be configured to determine additional contact information associated with an identified owner of the parcel of land. For example, the system may determine a telephone number and/or email address associated with the owner, such that the system operator may contact the owner using the additional contact information.

The method 200 may then proceed to ending block 235.

Embodiments of the present disclosure provide a hardware and software platform operative as a distributed system of modules and computing elements.

Platform 100 may be embodied as, for example, but not be limited to, a website, a web application, a desktop application, backend application, and a mobile application compatible with a computing device 300. The computing device 300 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

Platform 100 may be hosted on a centralized server or a cloud computing service. Although method 200 has been described to be performed by a computing device 300, it should be understood that, in some embodiments, different operations may be performed by a plurality of the computing devices 300 in operative communication at least one network.

Embodiments of the present disclosure may comprise a system having a central processing unit (CPU) 320, a bus 330, a memory unit 340, a power supply unit (PSU) 350, and one or more Input/Output (I/O) units. The CPU 320 coupled to the memory unit 340 and the plurality of I/O units 360 via the bus 330, all of which are powered by the PSU 350. It should be understood that, in some embodiments, each disclosed unit may actually be a plurality of such units for the purposes of redundancy, high availability, and/or performance. The combination of the presently disclosed units is configured to perform the stages of any method disclosed herein.

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, the memory unit 340, consistent with embodiments of the disclosure.

With reference to FIG. 3, a system consistent with an embodiment of the disclosure may include a computing device, such as computing device 300. In a basic configuration, computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

A system consistent with an embodiment of the disclosure the computing device 300 may include the clock module 310 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 320, the central component of modern computers, which relies on a clock. The only exceptions are asynchronous circuits such as asynchronous CPUs. The clock 310 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 300 use a “clock multiplier” which multiplies a lower frequency external clock to the appropriate clock rate of the CPU 320. This allows the CPU 320 to operate at a much higher frequency than the rest of the computer, which affords performance gains in situations where the CPU 320 does not need to wait on an external factor (like memory 340 or input/output 360). Some embodiments of the clock 310 may include dynamic frequency change, where the time between clock edges can vary widely from one edge to the next and back again.

A system consistent with an embodiment of the disclosure the computing device 300 may include the CPU unit 320 comprising at least one CPU Core 321. A plurality of CPU cores 321 may comprise identical CPU cores 321, such as, but not limited to, homogeneous multi-core systems. It is also possible for the plurality of CPU cores 321 to comprise different CPU cores 321, such as, but not limited to, heterogeneous multi-core systems, big.LITTLE systems and some AMD accelerated processing units (APU). The CPU unit 320 reads and executes program instructions which may be used across many application domains, for example, but not limited to, general purpose computing, embedded computing, network computing, digital signal processing (DSP), and graphics processing (GPU). The CPU unit 320 may run multiple instructions on separate CPU cores 321 at the same time. The CPU unit 320 may be integrated into at least one of a single integrated circuit die and multiple dies in a single chip package. The single integrated circuit die and multiple dies in a single chip package may contain a plurality of other aspects of the computing device 300, for example, but not limited to, the clock 310, the CPU 320, the bus 330, the memory 340, and I/O 360.

The CPU unit 320 may contain cache 322 such as, but not limited to, a level 1 cache, level 2 cache, level 3 cache or combination thereof. The aforementioned cache 322 may or may not be shared amongst a plurality of CPU cores 321. The cache 322 sharing comprises at least one of message passing and inter-core communication methods may be used for the at least one CPU Core 321 to communicate with the cache 322. The inter-core communication methods may comprise, but not limited to, bus, ring, two-dimensional mesh, and crossbar. The aforementioned CPU unit 320 may employ symmetric multiprocessing (SMP) design.

The plurality of the aforementioned CPU cores 321 may comprise soft microprocessor cores on a single field programmable gate array (FPGA), such as semiconductor intellectual property cores (IP Core). The plurality of CPU cores 321 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the aforementioned computing device 300, and/or the plurality of computing devices 300. The aforementioned communication system will be known to a person having ordinary skill in the art as a bus 330. The bus 330 may embody internal and/or external plurality of hardware and software components, for example, but not limited to a wire, optical fiber, communication protocols, and any physical arrangement that provides the same logical function as a parallel electrical bus. The bus 330 may comprise at least one of, but not limited to a parallel bus, wherein the parallel bus carry data words in parallel on multiple wires, and a serial bus, wherein the serial bus carry data in bit-serial form. The bus 330 may embody a plurality of topologies, for example, but not limited to, a multidrop/electrical parallel topology, a daisy chain topology, and a connected by switched hubs, such as USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 300 may employ hardware integrated circuits that store information for immediate use in the computing device 300, known to the person having ordinary skill in the art as primary storage or memory 340. The memory 340 operates at high speed, distinguishing it from the non-volatile storage sub-module 361, which may be referred to as secondary or tertiary storage, which provides slow-to-access information but offers higher capacities at lower cost. The contents contained in memory 340, may be transferred to secondary storage via techniques such as, but not limited to, virtual memory and swap. The memory 340 may be associated with addressable semiconductor memory, such as integrated circuits consisting of silicon-based transistors, used for example as primary storage but also other purposes in the computing device 300. The memory 340 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 300 may employ the communication system between an information processing system, such as the computing device 300, and the outside world, for example, but not limited to, human, environment, and another computing device 300. The aforementioned communication system will be known to a person having ordinary skill in the art as I/O 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces a plurality of hardware, such as, but not limited to, non-volatile storage 361, communication devices 362, sensors 363, and peripherals 364. The plurality of hardware is used by at least one of, but not limited to, human, environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ the non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using intermediate area in the memory 340. The non-volatile storage sub-module 361 does not lose data when power is removed and may be two orders of magnitude less costly than storage used in memory module, at the expense of speed and latency. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 300 may employ the communication sub-module 362 as a subset of the I/O 360, which may be referred to by a person having ordinary skill in the art as at least one of, but not limited to, computer network, data network, and network. The network allows computing devices 300 to exchange data using connections, which may be known to a person having ordinary skill in the art as data links, between network nodes. The nodes comprise network computer devices 300 that originate, route, and terminate data. The nodes are identified by network addresses and can include a plurality of hosts consistent with the embodiments of a computing device 300. The aforementioned embodiments include, but not limited to personal computers, phones, servers, drones, and networking devices such as, but not limited to, hubs, switches, routers, modems, and firewalls.

Two nodes can be said to be networked together, when one computing device 300 is able to exchange information with the other computing device 300, whether or not they have a direct connection with each other. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 362 may comprise a plurality of size, topology, traffic control mechanism and organizational intent. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 300 may employ the sensors sub-module 363 as a subset of the I/O 360. The sensors sub-module 363 comprises at least one of the devices, modules, and subsystems whose purpose is to detect events or changes in its environment and send the information to the computing device 300. Sensors are sensitive to the measured property, are not sensitive to any property not measured, but may be encountered in its application, and do not significantly influence the measured property. The sensors sub-module 363 may comprise a plurality of digital devices and analog devices, wherein if an analog device is used, an Analog to Digital (A-to-D) converter must be employed to interface the said device with the computing device 300. The sensors may be subject to a plurality of deviations that limit sensor accuracy. The sensors sub-module 363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 300 may employ the peripherals sub-module 362 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 300. Output devices convert electronically generated information into a form that can be presented to humans. Input/output devices perform both input and output functions. It should be understood by a person having ordinary skill in the art that the ensuing are non-limiting embodiments of the aforementioned peripheral sub-module 364:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 300 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g., devices disclosed in network 362 sub-module), data storage device (non-volatile storage 361), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method, comprising:
receiving image data, the image data being associated with positional metadata;
identifying one or more characteristics of the image data, the one or more characteristics being associated with presence of one or more items of interest at a particular site;
determining, based on the one or more identified characteristics, that the particular site includes the one or more items of interest;
determining a geographic position of the particular site based on the positional metadata associated with the image data;
determining a parcel of land that contains the determined geographic position; and
facilitating communication with an owner of the parcel of land.

2. The method of claim 1, wherein identifying the one or more characteristics associated with presence of the one or more items of interest comprises:
providing at least a portion of the received image data to a trained machine learning model as input, and
receiving, as output from the machine learning model, an indication of the presence of the one or more items of interest.

3. The method of claim 2, further comprising receiving, as output, an indication of a confidence level associated with the presence of the one or more items of interest.

4. The method of claim 1, wherein the positional metadata comprises geographical information associated an area of terrain depicted by the image data, and wherein determining the geographic position of the particular site comprises:
determining a relative position of the particular site depicted by the image data, and
estimating a geographic position of the particular site based on a relative position of the particular site in the image data.

5. The method of claim 1, wherein facilitating communication with the owner of the parcel of land comprises:
determining the owner of the parcel of land based on municipal records;
retrieving contact information associated with the determined owner; and
contacting the owner using the retrieved contact information.

6. The method of claim 1, further comprising determining an indication of a confidence level associated with the determination that the particular site includes the one or more items of interest; and
wherein determining the parcel of land that contains the determined geographic position is performed in response to the confidence level exceeding a threshold confidence level.

7. The method of claim 1, wherein identifying the one or more characteristics of the image data comprises identifying a plurality of characteristics of the particular site that, when correlated, indicates the presence of the one or more items of interest at the particular site.

8. One or more non-transitory computer readable media comprising instructions which, when executed by one or more hardware processors, causes performance of operations comprising:
receiving image data, the image data being associated with positional metadata;
identifying one or more characteristics of the image data, the one or more characteristics being associated with presence of one or more items of interest at a particular site;
determining, based on the one or more identified characteristics, that the particular site includes the one or more items of interest;
determining a geographic position of the particular site based on the positional metadata associated with the image data;
determining a parcel of land that contains the determined geographic position; and
facilitating communication with an owner of the parcel of land.

9. The non-transitory computer readable media of claim 8, wherein identifying the one or more characteristics associated with presence of the one or more items of interest comprises:
providing at least a portion of the received image data to a trained machine learning model as input, and
receiving, as output from the machine learning model, an indication of the presence of the one or more items of interest.

10. The non-transitory computer readable media of claim 9, the operations further comprising receiving, as output, an indication of a confidence level associated with the presence of the one or more items of interest.

11. The non-transitory computer readable media of claim 8, wherein the positional metadata comprises geographical information associated an area of terrain depicted by the image data, and wherein determining the geographic position of the particular site comprises:
determining a relative position of the particular site depicted by the image data, and
estimating a geographic position of the particular site based on a relative position of the particular site in the image data.

12. The non-transitory computer readable media of claim 8, wherein facilitating communication with the owner of the parcel of land comprises:
determining the owner of the parcel of land based on municipal records;
retrieving contact information associated with the determined owner; and
contacting the owner using the retrieved contact information.

13. The non-transitory computer readable media of claim 8, the operations further comprising determining an indication of a confidence level associated with the determination that the particular site includes the one or more items of interest; and
wherein determining the parcel of land that contains the determined geographic position is performed in response to the confidence level exceeding a threshold confidence level.

14. The non-transitory computer readable media of claim 8, wherein identifying the one or more characteristics of the image data comprises identifying a plurality of characteristics of the particular site that, when correlated, indicates the presence of the one or more items of interest at the particular site.

15. A system comprising:
at least one device including a hardware processor;
the system being configured to perform operations comprising:
receiving image data, the image data being associated with positional metadata;
identifying one or more characteristics of the image data, the one or more characteristics being associated with presence of one or more items of interest at a particular site;
determining, based on the one or more identified characteristics, that the particular site includes the one or more items of interest;
determining a geographic position of the particular site based on the positional metadata associated with the image data;
determining a parcel of land that contains the determined geographic position; and
facilitating communication with an owner of the parcel of land.

16. The system of claim 15, wherein identifying the one or more characteristics associated with presence of the one or more items of interest comprises:
providing at least a portion of the received image data to a trained machine learning model as input, and
receiving, as output from the machine learning model, an indication of the presence of the one or more items of interest.

17. The system of claim 16, the operations further comprising receiving, as output, an indication of a confidence level associated with the presence of the one or more items of interest.

18. The system of claim 15, wherein the positional metadata comprises geographical information associated an area of terrain depicted by the image data, and wherein determining the geographic position of the particular site comprises:
determining a relative position of the particular site depicted by the image data, and
estimating a geographic position of the particular site based on a relative position of the particular site in the image data.

19. The system of claim 15, wherein facilitating communication with the owner of the parcel of land comprises:
determining the owner of the parcel of land based on municipal records;
retrieving contact information associated with the determined owner; and
contacting the owner using the retrieved contact information.

20. The system of claim 15, the operations further comprising determining an indication of a confidence level associated with the determination that the particular site includes the one or more items of interest; and
wherein determining the parcel of land that contains the determined geographic position is performed in response to the confidence level exceeding a threshold confidence level.
